(19) United States
(12) Patent Application Publication
(10) Pub. No.: US 2012/0061185 A1
(43) Pub. Date: Mar. 15, 2012

(54) BUSHING LUBRICATOR AND SYSTEM

(75) Inventors: Brankin Brehmer, New Bern, NC (US); Ken Edwards, New Bern, NC (US); Gabriele McCurdy, New Bern, NC (US); Gregor Michalik, New Bern, NC (US); Sean Parnell, New Bern, NC (US); Rexford Smith, New Bern, NC (US)

(73) Assignee: BSH HOME APPLIANCES CORPORATION, Huntington Beach, CA (US)

(21) Appl. No.: 12/879,219

(22) Filed: Sep. 10, 2010

(51) Int. Cl. F16N 7/00; F16N 21/02

(52) U.S. Cl. 184/14; 184/105.3

(57) ABSTRACT

A bushing lubricator includes an elongate body having a lubricant passage extending from an inlet opening to an outlet port. The elongate body includes a connection portion at the inlet opening for engaging with a lubricant tray of a lubricating system, a main body portion in a central region, and a bushing lubricator portion of a width to accommodate a bushing with an interior surface of the bushing surrounding the bushing lubricator portion. The outlet port on a periphery of the bushing lubricator portion discharges lubricant onto the interior surface of a bushing.

### FIELD OF THE INVENTION

The present invention relates to a bushing lubricator and system for lubricating parts, such as bushings, with lubricant, such as oil. More particularly, the present invention relates to such a bushing lubricator and system which ensures adequate lubrication of bushings used in domestic appliances, prior to assembly of the appliance, in an efficient and speedy manner.

### BACKGROUND OF THE INVENTION

Domestic appliances in use today require a number of moving parts, for example, tensioning arms, or other like parts, which require the use of bushings. Prior to assembling such domestic appliances, in order to ensure proper functioning, the bushings must be lubricated, such as with oil, on their interior surface.

Current approaches to lubricating bushings in an assembly process involve manually picking up the bushing and using a bottle applicator to inject lubricating fluid or oil on the interior surfaces of the bushing. A problem with such systems, however, is that there is no way to ensure that the entire surface on the interior of the bushing is adequately lubricated and that consistent amount of lubricant is applied to each bushing, thus causing possible problems in operation of the domestic appliance after assembly. In addition, the process is inefficient and is manually intensive, thus slowing assembly on the production line. Further, current approaches do not provide an efficient or effective way to capture excess oil generated as a result of the bushing lubrication process.

In accordance with the present invention, such disadvantages are avoided by providing a novel bushing lubricator and system, which can be used to efficiently lubricate bushings during assembly, for example, of domestic appliances.

### SUMMARY OF THE INVENTION

In one aspect, the invention is directed to a bushing lubricator that includes an elongate body having a lubricant passage extending from an inlet opening to an outlet port. The elongate body includes a connection portion at the inlet opening for engaging with a lubricant tray of a lubricating system, a main body portion in a central region, and a bushing lubricator portion of a width to accommodate a bushing with an interior surface of the bushing surrounding the bushing lubricator portion. The outlet port on a periphery of the bushing lubricator portion discharges lubricant onto the interior surface of a bushing.

The connection portion of the elongate body may be threaded. The bushing lubricator may be made of metal, such as stainless steel or brass. The bushing lubricator also preferably includes at least one cut-out section along an outer surface of the main body portion for directing excess lubricant to flow along the cut-out section. A flange may be provided extending perpendicularly from the main body portion and may include corresponding cut-out sections coextensive with the cut-out sections of the main body portion for directing excess lubricant to flow away from the bushing lubricator. The outlet port on a periphery of the bushing lubricator portion may include a plurality of outlet ports.

In another aspect, the invention relates to a lubricating system for lubricating bushings, that includes a housing, a lubricant tray in the housing, a bushing lubricator with an elongate body connected to the lubricant tray and having a lubricant passage extending from an inlet opening to an outlet port. The elongate body further includes a connection portion at the inlet opening connecting with the housing, a main body portion in a central region, and a bushing lubricator portion of a width to accommodate a bushing with an interior surface of the bushing surrounding the bushing lubricator portion, the outlet port on a periphery of the bushing lubricator portion for discharging lubricant onto the interior surface of a bushing, and a lubricant supply fluidly connected to the bushing lubricator, and a controller for controlling the lubricant supply.

In a more specific aspect, the system includes a discharge tube in fluid communication with the bushing lubricator for discharging excess lubricant from the bushing lubricator. A sensor may be associated with the lubricant tray for detecting the presence of a bushing. A controller may be connected to the sensor and to the lubricant supply source for causing the lubricant supply source to supply lubricant (e.g., oil) to the bushing lubricator when the presence of a bushing is detected by the sensor. The controller may be programmed to cause the lubricant supply source to supply a predetermined amount of lubricant in response to the type of bushing being lubricated. In one additional aspect, the lubricant supply source may further include a selectively actuatable lubricant supply valve connected for dispensing lubricant to the bushing lubricator, and controlled by the controller.

### BRIEF DESCRIPTION OF THE DRAWINGS

These and other aspects and features of embodiments of the present invention will be better understood after a reading of the following detailed description, together with the attached drawings, wherein:

FIG. 1 is a perspective view of a bushing lubricator 11 in accordance with an exemplary embodiment the invention;

FIG. 2 is a side view of the bushing lubricator 11 of FIG. 1;

FIG. 3 is a side cross-sectional view of the bushing lubricator 11 along line A-A of FIG. 2;

FIG. 4 is a top cross-sectional view along of the bushing lubricator 11 along line B-B of FIG. 2;

FIG. 5 is a top plan view of the bushing lubricator 11 of FIG. 1;

FIG. 6 is a top plan view of a portion of a lubricating system 31 in accordance with an exemplary embodiment of the invention;

FIG. 7 is a side cross-sectional view of a portion of the lubricating system 31 along line C-C of FIG. 6;

FIG. 8 is another side cross-sectional view of a portion of the lubricating system 31 along line 8-8 of FIG. 6, along with a perspective view of a protective platform 110;

FIG. 9 is a perspective view of a portion of a bushing platform 20, with a lubricant tray 43 removed, of the lubricating system 31;

FIG. 10 is a perspective view of a portion of the lubricating system 31 with bushing 93 being mounted on the lubricating system 31; and

FIG. 11 is a perspective view of a bushing 93 mounted on the lubricating system 31 with a controller 103 that controls operation.

### DETAILED DESCRIPTION OF EXEMPLARY EMBODIMENTS OF THE INVENTION

The present invention is described more fully below with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

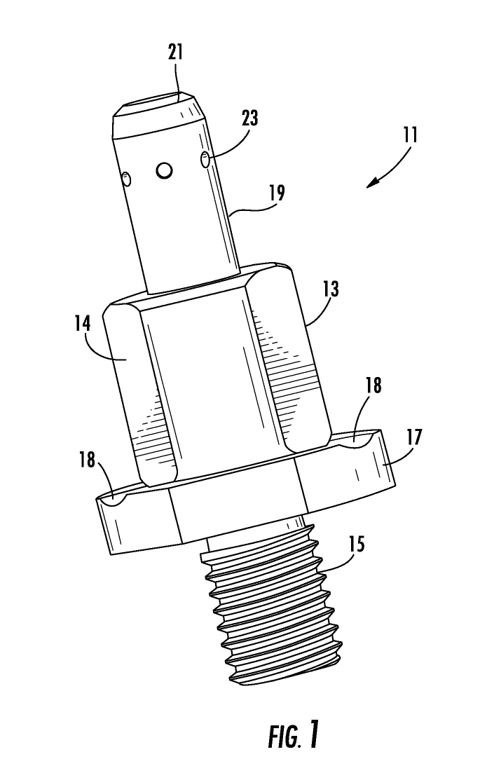

FIGS. 1 through 5 illustrate a bushing lubricator 11 in accordance with the invention. Bushing lubricator 11 includes a connecting portion 15 which connects to a supply of lubricant, for example oil or other suitable lubricant known to those of ordinary skill. To achieve a connection between connecting portion 15 and a lubricant supply source (not shown), threads may be provided on connecting portion 15, as illustrated in FIGS. 1-3. Connecting portion 15 connects to a main body portion 13, preferably having a flange 17 with cut-out sections 18, which are co-extensive with cut-out sections 14 of main body portion 13. Main body portion 13 also connects to a bushing lubricator portion 19, having at least one outlet port 23, and preferably a plurality, through which lubricant can be provided to interior surfaces of a bushing to be mounted on bushing lubricator portion 19.

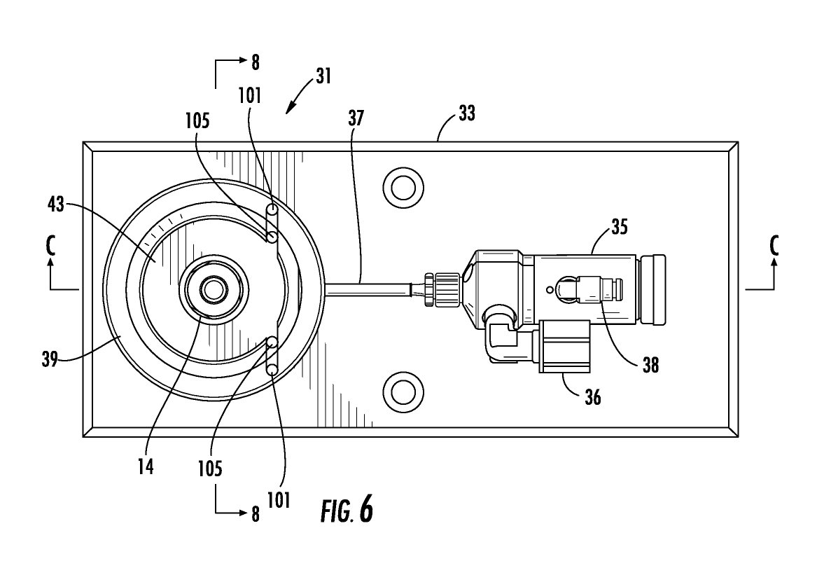

Bushing lubricator portion 19 is closed at a top portion 21, and includes a lubricant passage 91 (as shown in FIG. 3). Preferably, bushing lubricator 11 is made of durable material, for example stainless steel, brass, or other suitable durable material known to those of ordinary skill. Cut-out sections 18, of flange 17, which are co-extensive with cut-out sections 14, of main portion 13, allow excess lubricant flowing from outlet ports 23 to flow down and away from bushing lubricator 11, as described in more detail below.

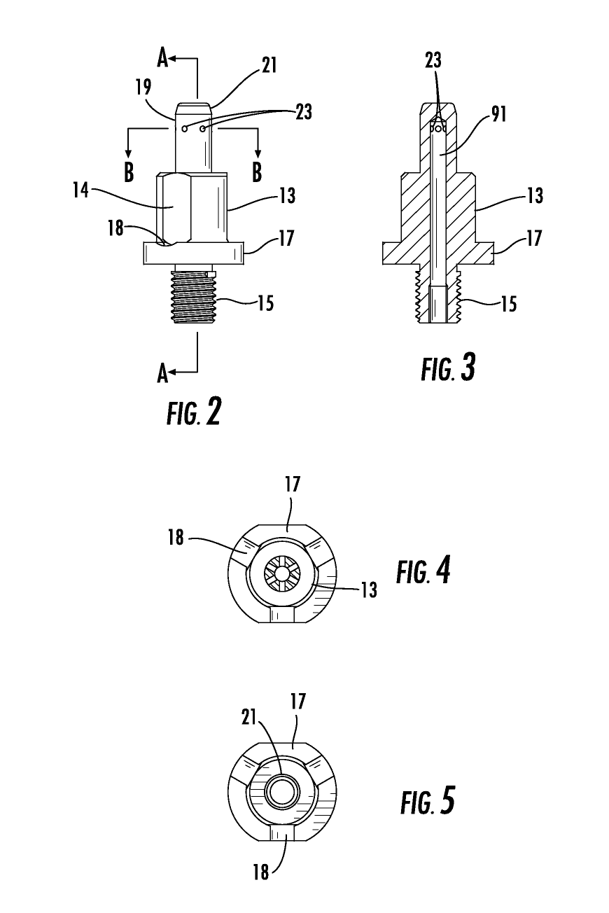

FIG. 2 shows bushing lubricator 11 in side view, and further shows cut-out sections 18 of flange 17 co-extensive with cut-out sections 14 of main body portion 13.

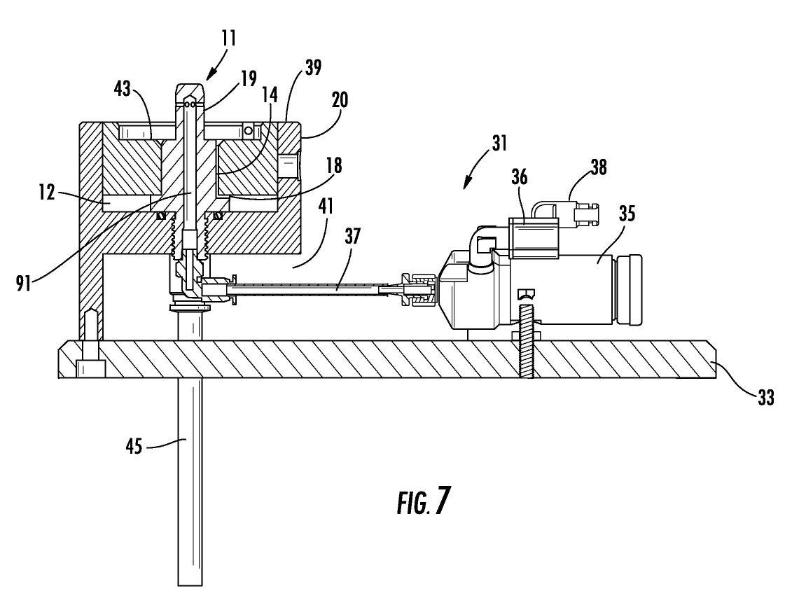

FIG. 3 is a cross sectional view taken along line A-A of FIG. 2 showing lubricant passage 91 to allow flow of lubricant to outlet ports 23. FIG. 4 is a top cross sectional view of bushing lubricator 11 taken along line B-B of FIG. 2, and FIG. 5 shows a top plane view of bushing lubricator 11.

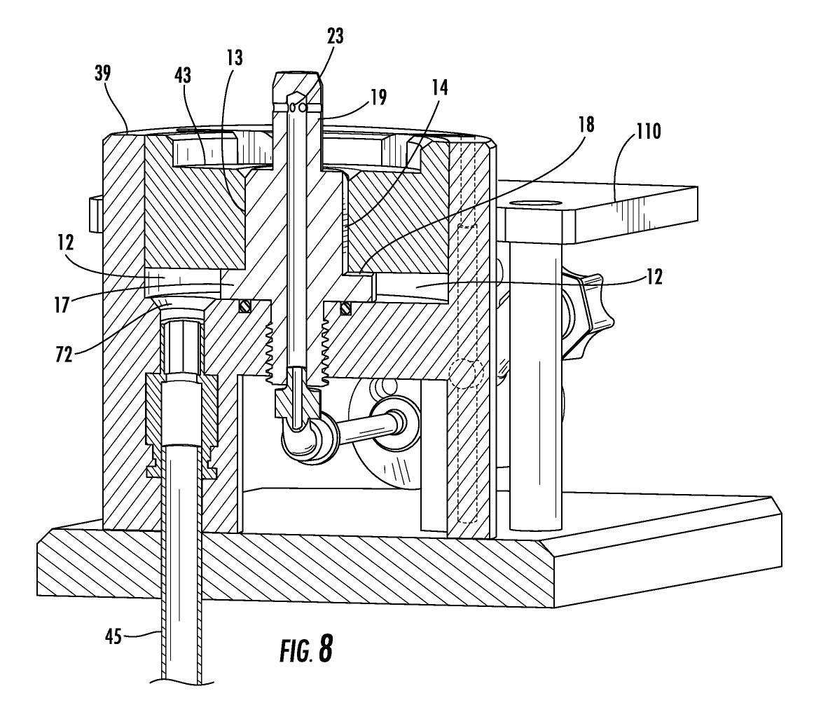

As further illustrated in FIGS. 6 through 11, bushing lubricator 11 can be part of a bushing lubricating system 31 for lubricating a bushing 93 which may be received on bushing lubricator portion 19. Bushing lubricating system 31 includes a base 33 that supports a bushing platform 20 and optionally a protective platform 110. Bushing platform 20 includes a wall 39 and a lubricant tray 43 on which a bushing 93 may be supported when mounted on bushing lubricator 11. Optional protective platform 110 is mounted to base 33 such that it is positioned substantially over the top of lubricant supply valve 35 and lubricant supply tube 37 (shown in FIG. 8). Protective platform 110 provides a protective barrier between lubricant supply valve 35 and lubricant supply tube 37, and an operator during operation of bushing lubricating system 31.

As discussed above, bushing lubricator 11 includes lubricant passage 91 through which lubricant may be transmitted to outlet ports 23. Bushing lubricator 11 is mounted and connected, in an exemplary embodiment, in threaded engagement under bushing platform 20, to lubricant supply tube 37 which passes through wall 39 via passage 41, and is connected to lubricant supply valve 35. Lubricant supply valve 35 is in fluid communication with a pressurized lubricant supply reservoir (not shown) at lubricant inlet 36. Lubricant supply valve 35 is controlled by a pneumatic control signal received at control signal inlet 38 from a controller 103.

In operation, the lubricant in pressurized lubricant supply reservoir is held under pressure. Upon receiving a pneumatic signal from controller 103 at control signal inlet 38 lubricant supply valve 35 opens and permits the lubricant to flow from lubricant inlet 36 to lubricant supply tube 37 to lubricant passage 91 and out through outlet ports 23 (for lubricating a bushing 93). After a predetermined time has passed, controller 103 sends a pneumatic signal to control signal inlet 38 and lubricant supply valve 35 closes and remains closed until a pneumatic signal is received from controller 103.

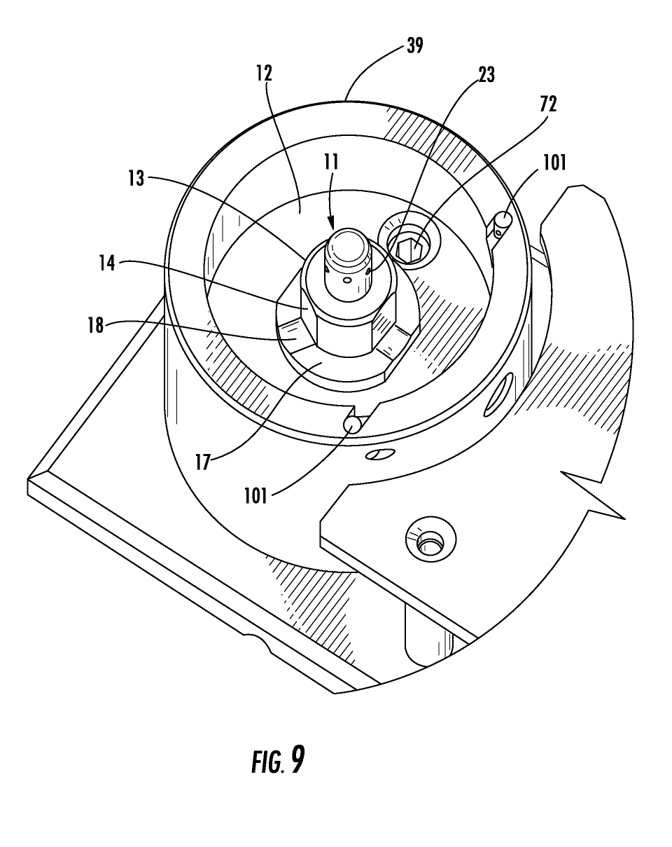

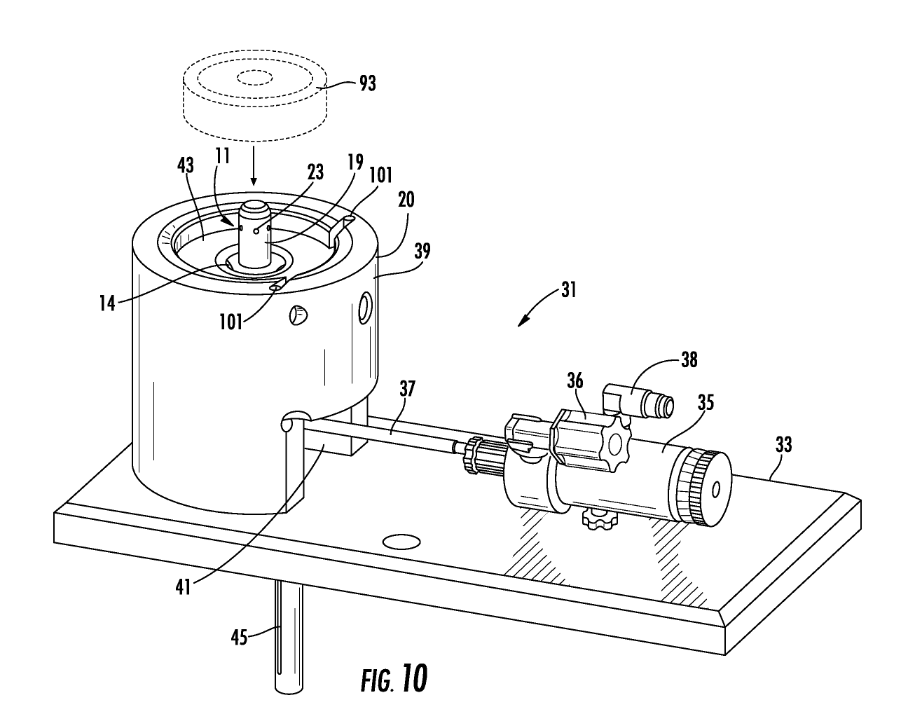

Bushing lubricating system 31 further includes an excess lubricant collection feature. Excess lubricant generated from use of bushing lubricating system 31 (i.e., that beyond what is needed to lubricate bushing 93) may be discharged along the sides of main body portion 13 of bushing lubricator 11 along cut-out sections 14 of main body portion 13 and then to cut-out sections 18 of flange 17 and into collection chamber 12. The excess lubricant then flows from collection chamber 12 through an oil drain passage 72 (shown in FIG. 8, and FIG. 9 with lubricant tray 43 removed), into a discharge tube 45 from where, the excess lubricant is collected and may be recycled. In a preferred embodiment the excess lubricant is gravity fed from main body portion 13 ultimately to discharge tube 45.

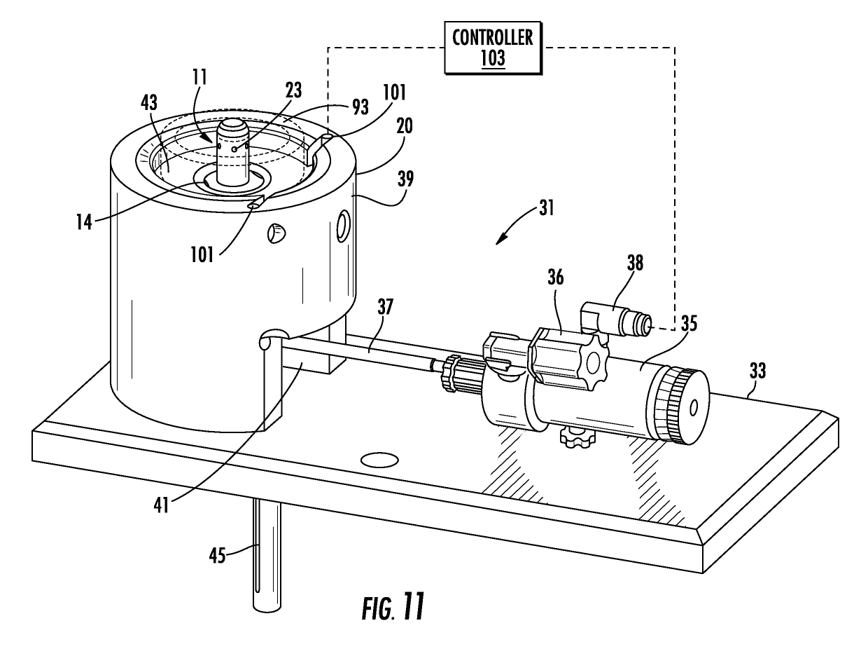

With reference to FIGS. 10 and 11, bushing 93 to be lubricated may be lowered and supported by lubricant tray 43 encircling bushing lubricator portion 19. A sensor 101 may be provided, such as a light sensor, or other type of sensor known to those of ordinary skill, which is connected to the controller 103.

Sensor 101 is a light sensor including a sending unit and receiving unit, housed in notches that extends outwardly from lubricant tray 43 into wall 39 (see FIG. 6) and arranged to allow the sending unit and receiving unit of sensor 101 to be in visual communication. Lubricant tray 43 further preferably includes sensor wells 105 to prevent excess lubricant from coming in contact with the send unit or receiving unit of sensor 101. In the event of excess lubricant build up in lubricant tray 43, sensor wells 105 prevent the excess lubricant from coming into contact with sensor 101 by draining the excess lubricant away from sensor 101, thus keeping sensor 101 clean during operation.

In operation, the sending unit of sensor 101 sends a light beam that crosses through a portion of lubricant tray 43, and is sensed by the receiving unit of sensor 101. When a bushing 93 is mounted on bushing lubricator portion 19, it breaks the light beam and controller 103 receives a signal from sensor 101. In response, controller 103 controls lubricant supply valve 35 to open for a preset amount of time to dispense an appropriate amount of lubricant through lubricant supply tube 37 to lubricant passage 91 and out through outlet ports 23 of bushing lubricator portion 19.

Controller 103 may be programmed in accordance with a type, e.g., size, of bushing 93 to control the predetermined amount of time which lubricant supply valve 35 is controlled to be open. In one example, lubricant supply valve 35 may remain open for about 0.5 seconds.

Bushing lubricator 11 may be in the range of about 60 mm to 65 mm in length, and preferably about 60 mm in length. Internal passage 91 may be in the range of about 4 mm to 4.2 mm in diameter, and preferably about 4.2 mm in diameter. At flange 17, bushing lubricator 11 may be in the range of about 28 mm to 30 mm wide, and preferably about 30 mm wide. Connecting portion 15 may be in the range of about 16 mm to 20 mm in length, and preferably about 16 mm in length and bushing lubricator portion 19 may be in the range of about 19 mm to 25 mm in length, and preferably about 19 mm in length.

The present invention has been described in terms of an exemplary embodiment. However, modifications and additions to this embodiment is apparent to those of ordinary skill in the art. It is intended that all such modifications and additions comprise a part of the present invention.

What is claimed is:

1. A bushing lubricator, comprising:
an elongate body having a lubricant passage extending from an inlet opening to an outlet port, the elongate body further comprising:
a connection portion at the inlet opening for engaging with a lubricant tray of a lubricating system;
a main body portion in a central region; and
a bushing lubricator portion of a width to accommodate a bushing with an interior surface of the bushing surrounding the bushing lubricator portion, the outlet port on a periphery of the bushing lubricator portion for discharging lubricant onto the interior surface of a bushing.

2. The bushing lubricator of claim 1, wherein the connection portion is threaded.

3. The bushing lubricator of claim 1, wherein the bushing lubricator comprises metal.

4. The bushing lubricator of claim 3, wherein the metal comprises one of stainless steel and brass.

5. The bushing lubricator of claim 1, further comprising a cut-out section along an outer surface of the main body portion for directing excess lubricant to flow along the cut-out section.

6. The bushing lubricator of claim 5, wherein the cut-out section comprises a plurality of cut-out sections.

7. The bushing lubricator of claim 5, further comprising a flange extending perpendicularly from the connection portion, wherein the flange includes a cut-out section that corresponds with the cut-out section of the main body portion for directing excess lubricant away from the main body portion.

8. The bushing lubricator of claim 1, wherein the outlet port comprises a plurality of outlet ports.

9. A lubricating system for lubricating bushings, comprising:
a housing;
a lubricant tray in the housing;
a bushing lubricator with an elongate body connected to the lubricant tray and having a lubricant passage extending from an inlet opening to an outlet port, the elongate body further comprising:
a connection portion at the inlet opening connecting with the housing;
a main body portion in a central region; and
a bushing lubricator portion of a width to accommodate a bushing with an interior surface of the bushing surrounding the bushing lubricator portion, the outlet port on a periphery of the bushing lubricator portion for discharging lubricant onto the interior surface of a bushing; and
a lubricant supply fluidly connected to the bushing lubricator; and
a controller for controlling the lubricant supply.

10. The system of claim 9, wherein the connection portion of the bushing lubricator is threadably connected to the housing.

11. The system of claim 9, wherein the bushing lubricator comprises one of stainless steel and brass

12. The system of claim 9, wherein the lubricant tray comprises aluminum.

13. The system of claim 9, further comprising a discharge tube for discharging excess lubricant from the housing.

14. The system of claim 13, wherein the bushing lubricator further comprises a cut-out section along an outer surface of the main body portion for directing excess lubricant to flow along the cut-out section toward the discharge tube.

15. The system of claim 14, wherein the cut-out section comprises a plurality of cut-out sections.

16. The bushing lubricator of claim 9, wherein the outlet port comprises a plurality of outlet ports.

17. The system of claim 9, further comprising a sensor associated with the lubricant tray for detecting the presence of a bushing.

18. The system of claim 17, wherein the controller is connected to the sensor and to the lubricant supply for controlling the lubricant supply to supply lubricant to the bushing lubricator when the sensor detects a bushing.

19. The system of claim 18, wherein the controller controls the lubricant supply source to supply a predetermined amount of lubricant based upon a type of bushing being lubricated

20. The system of claim 18, wherein the lubricant supply comprises a lubricant supply valve fluidly connected to a pressurized lubricant supply reservoir.
